(19) United States
(12) Patent Application Publication
(10) Pub. No.: US 2005/0288426 A1
(43) Pub. Date: Dec. 29, 2005

(54) Crosslinkable, photoactive polymers and their use

(76) Inventors: Peggy Studer, Huningue (FR); Patrick Scheifele, Therwil (CH); Richard Stossel, Frenkendorf (DE); Yonetatsu Matsumoto, Kobe (JP); Stefan Barny, Oberwil (CH)

Correspondence Address: WENDEROTH, LIND & PONACK, L.L.P., 2033 K STREET N. W., SUITE 800, WASHINGTON, DC, 20006-1021, US

(21) Appl. No.: 10/537,546

(22) PCT Filed: Dec. 2, 2003
(86) PCT No.: PCT/EP03/50926

§ 371 Date: Jul. 13, 2005

(30) Foreign Application Priority Data
Dec. 6, 2002 (CH) 2074/02
Jun. 23, 2003 (CH) 1095/03

(51) Int. Cl. C08F 20/54

(52) U.S. Cl. 524/555; 524/556; 526/317.1; 526/319; 526/303.1

(57) ABSTRACT

Copolymers composed of (a) at least one monomer from the group of acrylates, methacrylates, acrylamides and methacrylamides, to each of which is bonded covalently, directly or via a bridging group, a photochemically isomerizable or dimerizable molecule, (b) at least one polyoxyalkyl ester or one polyoxyalkylamide of an ethylenically unsaturated mono- or dicarboxylic acid, or one polyoxyalkyl ether of an ethylenically unsaturated alcohol, and (c) optionally, other ethylenically unsaturated comonomers are outstandingly suitable as alignment layers for liquid crystals.

The present invention relates to copolymers composed of (a) at least one ethylenically unsaturated monomer to which a photochemically isomerizable or dimerizable molecule is covalently bonded, (b) a polyoxyalkyl ester or a polyoxyalkylamide of an ethylenically unsaturated mono- or dicarboxylic acid and/or a polyoxyalkyl ether of an ethylenically unsaturated alcohol, and (c) optionally, other ethylenically unsaturated monomers; to a polymerizable composition comprising the monomers (a), (b) and optionally a solvent; to an electrooptical device comprising, on a (flat) backing material, an optionally photocrosslinked layer of the copolymer; and to the use of the copolymers as an alignment layer for liquid crystals.

In recent times, alignment layers for liquid crystals have played a considerable role in the production of electrooptical elements, for example liquid crystal displays. These alignment layers can also, in combination with liquid crystal polymers, be used for the production of optical compensation films, for example, among other uses, for optical delay filters, cholesteric filters, antireflection filters and for security elements. Such alignment layers are polymers which are applied to a backing and, on irradiation with (polarized) light of suitable wavelength and energy density, are crosslinked over the whole surface or selectively. In liquid crystal displays and also compensation films, the alignment layer has to impart not only the alignment direction but also a tilt angle, and its size determines the application possibilibes. Depending on the type, different tilt angles are required for the production of liquid crystal displays (supertwisted nematic LCDs having relatively large tilt angles >15°, or TN and TFT-TN LCDs having a relatively small tilt angle between 1° and 15°). In security elements, an alignment direction without tilt angle is sufficient, which can achieve a high contrast.

U.S. Pat. No. 5,539,074 discloses homo- and copolymers having covalently bonded photodimerizable or photoisomerizable groups for the use of alignment layers. There is no mention of monomers containing hydroxyl groups and it is said that these should even be avoided as a consequence of undesired solubility of ions. The glass transition temperatures of the polymeric (meth)acrylate structural elements are above 35° C. and extend up to 165° C.

EP-A-0 763 552 describes polymers of 3-aryl(meth)acrylic esters and 3-aryl-(meth)acrylamides with photodimerizable cinnamic acid radicals for the use of alignment layers. These are preferably homopolymers, although copolymers are also mentioned which may contain, for example, structural elements of hydroxyalkyl (meth)acrylic esters. The glass transition temperatures are generally above 70° C.

WO 96/10049 discloses homo- and copolymers having covalently bonded photoreactive coumarin or quinolinone groups for producing alignment layers, and possible comonomers which are mentioned also include hydroxyalkyl (meth)acrylates. The polymers, and especially the copolymers with hydroxyethyl methacrylates, have glass transition temperatures well above 100° C.

EP-A-0 860 455 describes homo- and copoly(meth)acrylates having covalently bonded photoreactive cinnamic acid radicals for producing alignment layers, and possible comonomers which are mentioned also include hydroxyalkyl (meth)acrylates. There is no information about glass transition temperatures.

The existing polymers for producing alignment layers have the disadvantage that polymeric layers of liquid crystals adhere only inadequately to the polymeric alignment layer. In addition, such polymers often have insufficient photosensitivity, which manifests itself in excessively long irradiation times. A further disadvantage of the existing alignment layers is also that mixtures of polymers having photoactive monomers generally have to be used to achieve smaller or larger tilt angles. The alignment layers often form regions (domains) with tilt angles which, viewed overall, reduce the contrast

It has now been found that, surprisingly, the adhesion and photostability, and thus the lifetime, but also the photosensitivity and, at the same time, the stability of the tilt angle can be considerably improved, that outstanding and uniform contrast behaviour can be achieved, and that, starting from a photoactive monomer, it is possible to achieve, in a targeted manner, no tilt angle or small to large and stable tilt angles with a liquid crystal layer when copolymers are used for the production of alignment layers which are based on (meth)acrylates and, in addition to monomers having photoactive groups, also contain comonomers having polyoxyalkylene radicals. It has also been found that such copolymers also have surprisingly high adhesion to substrates when they have a low glass transition temperature, for example at most 70° C. and preferably at most 60° C.

The present invention first provides a copolymer composed of
(a) at least one monomer from the group of acrylates, methacrylates, acrylamides and methacrylamides, to each of which is bonded covalently, directly or via a bridging group, a photochemically isomerizable or dimerizable molecule,
(b) at least one comonomer containing hydroxyl groups, and
(c) optionally, other ethylenically unsaturated comonomers,
   characterized in that the comonomer (b) is a polyoxyalkyl ester or a polyoxyalkylamide of an ethylenically unsaturated mono- or dicarboxylic acid, or a polyoxyalkyl ether of an ethylenically unsaturated alcohol, and the hydroxyl group of the polyoxyalkylene radical may be etherified or esterified.

The copolymers according to the invention are random copolymers.

Photochemically isomerizable and dimerizable molecules are, for example, those molecules which undergo a cis/trans isomerization or a [2+2]-cycloaddition under the influence of radiation and lead to crosslinking of the polymer.

The photoisomerizable group may, for example, be azobenzene groups.

The photodimerizable group may, for example, be ethylenically unsaturated groups which are preferably bonded to a carbocyclic or heterocyclic, aromatic ring. Particular preference is given to an alkoxycarbonyl group being bonded to the ethylenically unsaturated group, for example C₁-C₁₂-alkoxycarbonyl, preferably C₁-C₆-alkoxycarbonyl and more preferably C₁-C₄-alkoxycarbonyl. Examples of alkoxy are methoxy, ethoxy and the isomers of propoxy, butoxy, pentoxy, hexoxy, heptoxy, octoxy, nonoxy, decoxy, undecoxy and dodecoxy. Particular preference is given to alkoxy being ethoxy and particularly methoxy. In a further preferred embodiment, the ethylenically unsaturated group is bonded to the polymer backbone via a C(O) group and a bridging group bonded thereto, and an optionally substituted aryl or heteroaryl group is bonded to the second carbon atom of the ethylenically unsaturated group. The photodimerizable group may, for example, be derivatives of cinnamate, chalcone or coumarin.

The photopolymerizable group may, for example, correspond to the formulae A and B 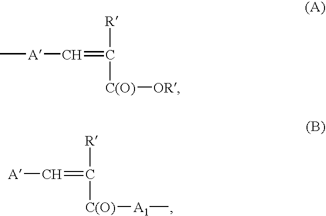
where
R′ is hydrogen or C₁-C₄-alkyl,
A′ is an optionally substituted mono- or divalent aromatic radical or an optionally substituted mono- or divalent heteroaromatic radical, and
A₁ is a bridging group.

In a preferred embodiment, R′ is methyl and in particular hydrogen.

A′ may, for example, be phenylene, pyrimidine-2,5-diyl, pyridine-2,5-diyl, 2,5-thiophenylene, 2,5-furanylene, 1,4- or 2,6-naphthylene. A′ may also be two or three such aromatic radicals joined, either directly or via a bridging group. Suitable bridging groups are, for example, O, S, NH, N(C₁-C₄-alkyl), C(O), C(O)O, OC(O)O, S(O), SO₂, S(O)O, OS(O)O, SO₂O, OSO₂O, Si(C₁-C₄-alkyl)₂, OP(OC₁-C₄-alkyl)O, P(OC₁-C₄-alkyl)O, P(O)(OC₁-C₄-alkyl)O, C₂-C₆-alkylidene and C₁-C₆-alkylene.

Suitable substitutents for A′ are, for example, C₁-C₆-alkyl, C₁-C₆-hydroxyalkyl, C₁-C₆-haloalkyl, C₆-C₁₀-aryl, C₇-C₁₂-aralkyl, C₁-C₆-alkoxy, C₁-C₆-hydroxyalkoxy, C₁-C₆-haloalkoxy, C₆-C₁₀-aryloxy, C₇-C₁₂-aralkyloxy, C₁-C₆-acyl, C₁-C₆-alkoxycarbonyl, C₁-C₆-hydroxy-alkoxycarbonyl, C₁-C₆-alkoxycarbonyloxy, C₁-C₆-hydroxyalkoxycarbonyloxy, C₁-C₆-alkyl-aminocarbonyl, C₁-C₆-alkylaminocarbonyl, C₁-C₆-alkylaminocarbonyloxy, C₁-C₆-dialkyl-aminocarbonyloxy, halogen (F, Cl and Br), OH, COOH, CONH₂, CN and nitro.

A′ as an aromatic radical is more preferably optionally substituted phenylene, naphthylene, biphenylene, or biphenylene joined via bridging groups, in which case the bridging groups are preferably selected from the group of O, S, CO, C(O), C(O)O, OC(O)O, NH, N-methyl, SO₂, methylene, ethylene, ethylidene and isopropylidene.

The bridging group A₁ may, for example, be C₁-C₂₀-alkylene and preferably C₁-C₁₄-alkylene, which is unsubstituted or substituted by fluorine, chlorine, cyano or C₁-C₆-alkoxy, and which is optionally interrupted by one or more identical or different heteroatoms or groups 4, —S—, —C(O)O—, —O(O)C—, —OC(O)O, —NH—, —NC₁-C₄-alkyl-, —NHC(O), —C(O)NH—, —NHC(O)NH—, —NC₁-C₄-alkyl-C(O)—, —C(O)—NC₁-C₄-alkyl-, —NC₁-C₄-alkyl-C(O)—NC₁-C₄-alkyl-, —O(CO)NH—, —OC(O)—NC₁-C₄-alkyl-, —NHC(O)O—, —NC₁-C₄-alkyl-C(O)O— and —CH═CH—.

The monomer of component (a) of the copolymers according to the invention is preferably selected from acrylate and, more preferably, methacrylate.

Monomers (a) are widely known and described, for example, in the literature cited at the outset or can be prepared by similar processes.

The monomers (a) may correspond to the formula I or the formula Ia 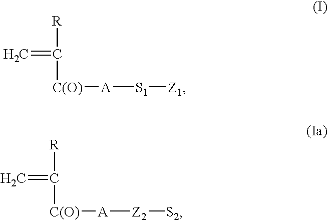
where
R is H or C₁-C₆-alkyl,
A is a bridging group,
S₁ is an optionally substituted divalent, and S₂ an optionally substituted monovalent, aromatic or heteroaromatic radical, and
Z₁ is a monovalent, and Z₂ a divalent, radical of a molecule which isomerizes or dimerizes photochemically.

For S₁, S₂, Z₁ and Z₂, the preferences and the embodiments given for the groups of the formulae (A) and (B) apply.

When R is alkyl, it is preferably C₁-C₄-alkyl, for example butyl, propyl, ethyl and more preferably methyl.

The bridging group A may be C₁-C₂₀-alkylene and preferably C₁-C₁₆-alkylene, which is unsubstituted or substituted by fluorine, chlorine, cyano or C₁-C₆-alkoxy, and is optionally interrupted by one or more identical or different heteroatoms or groups —O—, —S—, —C(O)O—, —O(O)C—, —OC(O)O—, —NH—, —NC₁-C₄-alkyl-, —NHC(O)—, —C(O)NH—, —NHC(O)NH—, —NC₁-C₄-alkyl-C(O)—, —C(O)—NC₁-C₄-alkyl-, —NC₁-C₄-alkyl-C(O)—NC₁-C₄-alkyl-, —O(CO)NH—, —OC(O)—NC₁-C₄-alkyl-, —NHC(O)O—, —NC, —C₄-alkyl-C(O)O— and —CH═CH—.

The monomers (a) preferably correspond to the formula Ib or to the formula Ic, 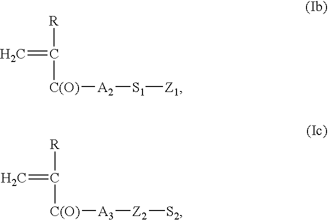
where
R is hydrogen or methyl,
A₂ is a bivalent radical of the formula O—CₙH₂ₙ, —X₁—,
A₃ is a bivalent radical of the formula —O—CₙH₂ₙ—O—.
n is a number from 2 to 18 and preferably from 4 to 16,
X₁ is a direct bond or a —O—, —, —C(O)O—, —O(O)C—, —OC(O)O—, —NH—, —NC₁-C₄-alkyl-, —NHC(O)—, —C(O)NH—, —NHC(O)NH—, —NC₁-C₄-alkyl-C(O)—, —C(O)—NC₁-C₄-alkyl-, —NC₁-C₄-alkyl-C(O)—NC₁-C₄-alkyl-, —O(CO)NH—, —OC(O)—NC₁-C₄-alkyl-, —NHC(O)O— or —NC₁-C₄-alkyl-C(O)O— group,
S₁, where present, is phenylene, biphenylene or —C₆—H₄—X₂—H₄—,
S₂, where present, is substituted phenyl, biphenyl or —C₆—H₄—X₂—C₆H₅,
X₂ is —O—, —S—, —C(O)O—, —O(O)C—, OC(O)O—, —NH—, —NC₁-C₄-alkyl-, —NHC(O), —C(O)NH, —NHC(O)NH—, —NC₁-C₄-alkyl-(O), —C(O)NC₁-C₄-alkyl-, —NC₁-C₄-alkyl-C(O)—NC₁-C₄-alkyl-, —O(CO)NH—, —OC(O)—NC, —C₄-alkyl-, —NHC(O)O— or —NC₁-C₄-alkyl-C(O)O—,
Z₁ is a radical of the formula —H═CH—C(O)—OR₁,
Z₂ is a radical of the formula —CH═CH—C(O)—, and
R₁ is C₁-C₈-alkyl, more preferably C₁-C₁₂-alkyl, and especially preferably C₁-C₄-alkyl.

Preferred substituents for S₁ and S₂ are C₁-C₄-alkyl and C₁-C₄-alkoxy, in particular methoxy and ethoxy.

Examples of the CₙH₂ₙ group are methylene, ethylene, 1,2- or 1,3-propylene, 1,2-, 1,3- or 1,4-butylene, and also α,ω-alkylenes or isomers of pentylene, hexylene, heptylene, octylene, nonylene, decylene, undecylene, dodecylene, tridecylene, tetradecylene, pentadecylene, hexadecylene, heptadecylene, octadecylene, nonadecylene and eicosylene.

In a particularly preferred embodiment, the monomers (a) correspond to the formula Id or to the formula Ie 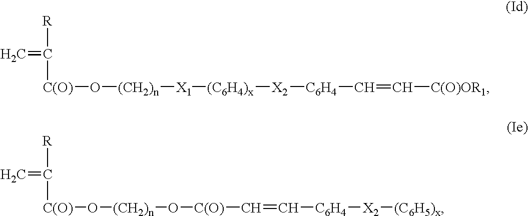
where
R is methyl,
n is a number from 2 to 20, preferably from 4 to 14,
R₁ is C₁-C₄-alkyl and preferably methyl,
x is 0 or 1,
X₂ is a direct bond, —O—, —S—, —O—, —OC(O)— or —C(O)O—, and
the C₆H₄ and C₆H₅ groups are each independently unsubstituted or substituted by 1 to 3 C₁-C₄-alkyl and/or C₁-C₄-alkoxy, preferably methoxy.

The comonomers (b) may, for example, correspond to the formula II 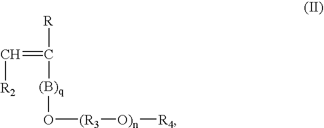
where
R is H or C₁-C₄-alkyl,
R₂ is H or —COOR₅,
R₃ is C₂-C₆alkylene,
R₄ is H, —R₆— or R₆—C(O)—,
B is methylene or —C(O)—,
q is 0 or 1,
n is a number from 2 to 200,
R₅ is H, C₁-C₂₀-alkyl, phenyl, phenyl-C₁-C₆-alkyl or C₁-C₁₈-alkylphenyl, and
R₆ is C₁-C₂₀-alkyl, phenyl, phenyl-C₁-C₆-alkyl, or C₁-C₁₈-alkylphenyl, or, in the R₆—C(O)— group, is additionally C₂-C₁₈-alkenyl or phenyl-C₂-C₆-alkenyl.

R is preferably H and more preferably methyl. R₂ is preferably H. R₃ is preferably ethylene or 1,2-propylene or mixtures of these radicals. R₄ is preferably H, C₁-C₁₂-alkyl, and preferably C₁-C₄-alkyl, for example methyl, ethyl, propyl and butyl, or C₁-C₂-alkyl-C(O)— or C₂-C₆-alkenyl-C(O)—. B is preferably —C(O)—. The index n is preferably numbers from 2 to 100, more preferably from 2 to 50 and particularly preferably from 2 to 20.

In a particularly preferred embodiment, the comonomers of the formula II are acrylic or methacrylic monoesters of polyethylene glycols or polypropylene 1,2-glycols having particularly, on average, 2 to 20 oxyethylene or oxypropylene units.

The comonomers of the formula II are known or can be prepared by similar processes, and some of them are commercially available.

The monomers (c) are unsubstituted or substituted olefins, for example ethene, propene, butene, pentene, styrene, vinyl chloride, vinylidene chloride, (meth)acrylonitrile, (meth)acrylamide, N-alkylated or N-hydroxyalkylated (meth)acrylamide, alkyl (meth)acrylates and hydroxyalkyl (meth)acrylates having 1 to 20 carbon atoms in the ester group, vinyl and allyl esters, and also vinyl and allyl ethers, having 1 to 20 carbon atoms in the ester or ether groups.

The copolymers according to the invention may also contain radicals of monomers having at least two ethylenically unsaturated groups. Such crosslinking agents can be used to selectively attain desired physical and mechanical properties. A great variety of crosslinking agents is known. Some examples are butadiene, isoprene, divinylbenzene and acrylic or methacrylic esters of polyols, for example ethylene glycol, propylene glycol, butylene glycol, hexanediol, diethylene glycol, 1,2,3-propanetriol, trimethylolpropane and pentaerythritol.

The hydroxyl group of the polyoxyalkyl radicals in the copolymers according to the invention may also be partly or fully replaced by radicals of ethylenically unsaturated monocarboxylic acids, for example radicals of acrylic acid or methacrylic acid. Such copolymers are crosslinkable in the photopolymerization, which allows desired properties to be attained. Such copolymers are easy to prepare by partly or fully esterifying copolymers according to the invention which contain hydroxyl groups with appropriate unsaturated carboxylic acids or derivatives such as esters or halides. The amount of such esterified radicals in the copolymer depends on the content of the comonomers (b) and may, based on this content, be up to 100 mol %, more preferably 0.1 to 80 mol % and particularly preferably 1 to 60 mol %, based on the copolymer.

The glass transition temperature of the copolymers according to the invention is preferably at most 70° C., more preferably up to 60° C. and particularly preferably up to 50° C., when the intention is to attain improved adhesion to a substrate. For this improvement, it may also be at most 40° C. or preferably at most 35° C. The comonomers and the ratios of their amounts are selected in such a way that the desired glass transition temperature is attained. However, the glass transition temperature of the copolymers according to the invention may also be above 70° C. and, for example, be up to 140° C. when the adhesion to a substrate is controlled via surface treatment of the substrate, for example a plasma treatment. The rule of thumb is that the homopolymers of the comonomers (b) and (c) should have a lower glass transition temperature than homopolymers of comonomers (a). The lower limit of the glass transition temperature is not critical and may be lower than −100° C., preferably up to −50° C. and more preferably up to −20° C. The copolymers according to the invention may have molecular weights of 1000 to 1 000 000 dalton, preferably 5000 to 500 000 dalton. The copolymers are soluble in many organic solvents.

The amount of the comonomers may, based on the weight of the copolymer, be, for example, 10 to 95% by weight, preferably 50 to 90% by weight and more preferably 60 to 90% by weight, of comonomer (a), and 90 to 5% by weight, preferably 50 to 10% by weight and more preferably 40 to 10% by weight, of comonomer (b). Where a comonomer (c) is present, it may replace 50 to 1% by weight, preferably 40 to 5% by weight and more preferably 30 to 5% by weight, of comonomer (b). The percentages by weight add up to 100% by weight

The copolymers are prepared by processes known per se, by anionic, cationic or free-radical polymerization, in solution or in bulk, optionally with heating. The isolation can be effected by removal of solvents or precipitation by addition of nonsolvents, subsequent filtration and customary purification steps. The copolymers can be used as coating compositions for backing materials in the form of solutions. It has been found to be appropriate to use polymer solutions obtained in the preparation, optionally after removing a portion of the solvent, directly as coating compositions.

The present invention also provides coating compositions comprising in an organic solvent, a copolymer composed of
(a) at least one monomer from the group of acrylates, methacrylates, acrylamides and methacrylamides, to each of which is bonded covalently, directly or via a bridging group, a photochemically isomerizable or dimerizable molecule,
(b) at least one comonomer containing hydroxyl groups, and
(c) optionally, other ethylenically unsaturated comonomers, characterized in that the comonomer (b) is a polyoxyalkyl ester or a polyoxyalkylamide of an ethylenically unsaturated mono- or dicarboxylic acid, or a polyoxyalkyl ether of an ethylenically unsaturated alcohol, and the hydroxyl group of the polyoxyalkylene radical may be etherified or esterified.

Examples of suitable solvents are given hereinbelow.

However, it is also possible to dissolve the comonomers together with a polymerization initiator in suitable solvents, to apply the mixture to a surface and only then to thermally polymerize it, optionally under an inert atmosphere.

The present invention further provides a polymerizable composition comprising
(a) at least one monomer from the group of acrylates, methacrylates, acrylamides and methacrylamides, to each of which is bonded covalently, directly or via a bridging group, a photochemically isomerizable or dimerizable molecule,
(b) at least one copolymerizable comonomer containing hydroxyl groups,
(c) optionally, other ethylenically unsaturated comonomers,
(d) a polymerization initiator, and
(e) optionally, an inert solvent,
   characterized in that the comonomer (b) is a polyoxyalkyl ester or a polyoxyalkylamide of an ethylenically unsaturated mono- or dicarboxylic acid, or a polyoxyalkyl ether of an ethylenically unsaturated alcohol.

For the components (a), (b) and (c), the previously stated embodiments and preferences apply.

Among the polymerization initiators, preference is given to free-radical initiators which generate radicals thermally and/or by irradiation. Suitable for ethylenically unsaturated monomers are in particular azo compounds, for example 2,2′-azobisisobutyronitrile, 2,2′-azobis(2-methylbutyronitrile), 2,2′-azobis(2,4-dimethylvaleronitrile) or macroinitiators such as azo macroinitiators which contain, for example, polyethylene glycol units. Polymerization initiators are generally used in amounts of 0.1 to 10% by weight, based on the totality of the monomers.

Suitable solvents are, for example, aliphatic, cycloaliphatic and aromatic hydrocarbons (pentane, hexane, petroleum ether, cyclohexane, methylcyclohexane, benzene, toluene, xylene), aliphatic halohydrocarbons (methylene chloride, chloroform, dichloroethane and tetrachlorethane), nitriles (acetonitrile, propionitrile, benzonitrile), ethers (diethyl ether, dibutyl ether, t-butyl methyl ether, ethylene glycol dimethyl ether, ethylene glycol diethyl ether, diethylene glycol dimethyl ether, tetrahydrofuran, dioxane, diethylene glycol monomethyl ether or diethylene glycol monoethyl ether), ketones (acetone, methyl isobutyl ketone, cyclopentanone, cyclohexanone), carboxylic esters and lactones (ethyl acetate, or methyl acetate, valerolactone), n-substituted lactams (N-methylpyrrolidone), carboxamides, (dimethylacetamide, dimethylformamide), acyclic ureas (dimethylimidazoline), and sulfoxides and sulfones (dimethyl sulfoxide, dimethyl sulfone, tetramethylene sulfoxide, tetramethylene sulfone) and alcohols (methanol, ethanol, propanol, butanol, ethylene glycol monomethyl ether, ethylene glycol monoethyl ether, diethylene glycol monomethyl ether). The solvents can be used alone or in a mixture of at least two solvents.

The concentration of the copolymers or comonomers in the solutions depends substantially on the desired layer thickness which is to be achieved on a support, and also on the viscosity of the solutions. The amount of the comonomers may, for example, be 0.1 to 20% by weight, preferably 0.1 to 15% by weight and more preferably 0.5 to 10% by weight.

The polymerizable composition or the coating composition is outstandingly suitable for producing alignment layers by polymerization of a thin layer of said composition on a backing.

The invention also provides a composite material composed of a backing and a thin layer of a polymerizable composition or of a copolymer of this composition, comprising
(a) at least one monomer from the group of acrylates, methacrylates, acrylamides and methacrylamides, to each of which is bonded covalently, directly or via a bridging group, a photochemically isomerizable or dimerizable molecule,
(b) at least one copolymerizable comonomer containing hydroxyl groups,
(c) optionally, other ethylenically unsaturated comonomers, and
(d) a polymerization initiator,
   characterized in that the comonomer (b) is a polyoxyalkyl ester or a polyoxyalkylamide of an ethylenically unsaturated mono- or dicarboxylic acid, or a polyoxyalkyl ether of an ethylenically unsaturated alcohol.

For the components (a), (b), (c) and (d), the previously stated embodiments and preferences apply.

The layer thickness may be, for example, 0.01 to 500 μm, preferably 0.05 to 200 μm, more preferably 0.05 to 100 μm and especially preferably 0.05 to 50 μm. In optical applications, the thicknesses of alignment layers are frequently in the range from 10 to 100 nm.

Backing materials are known and their form may be different depending on the application.

Preference is given to flat and even backings. Examples of backing materials are aluminum oxide, titanium oxide, silicon dioxide (glass or quartz) or mixed oxides, for example indium tin oxide (ITO), and also plastics and organic glasses, for example polyethylene, polypropylene, polyesters such as polyethylene terephthalate, polycarbonates, polyurethane, polyamides, poly(meth)acrylic esters and triacetylcellulose. In inventive applications for optical devices, important backing materials are in particular plastics, glass or in some cases a backing (for example glass plates coated with ITO) coated with an electrically conductive material (which serves as an electrode).

The coated backing can be produced by coating processes known per se, for example brushing, dipping, roller coating, knife coating and flow coating. To prepare thin layers, spin coating has been found to be particularly useful, since uniform layer thicknesses can also be obtained. After the coating, the coated material is dried, for example by evaporating the solvent by means of heating, applying a vacuum or both measures. Compositions are thermally polymerized after the coating. The material obtained in this way having a layer of the copolymer according to the invention is stable and can be traded as such for further processing.

The coated material according to the invention is particularly suitable for aligning liquid crystals in a layer which is applied to the copolymer. To this end, the copolymer layer is initially irradiated with linear-polarized light and the photoactive groups are isomerized or dimerized. Suitable radiation sources are particularly UV sources, for example mercury high pressure lamps, xenon lamps or UV lasers using a polarizer. When structures are to be depicted, it is appropriate to irradiate through a mask. The irradiation times depend upon the output of the radiation sources and may range from a few seconds to hours. Liquid-crystalline compounds are then applied to the layers prepared in this way, and the compounds may be molecular compounds, polymers or polymerizable monomers or oligomers.

Such liquid-crystalline compounds are known and described in U.S. Pat. No. 55,993,617, U.S. Pat. No. 5,567,349, U.S. Pat. No. 5,650,534 and WO 99/64924 (see structures C and D.) Commercial liquid-crystal formulations such as OPALVA™ 2130 are obtainable from VANTICO AG (Basle). Structures C and D: 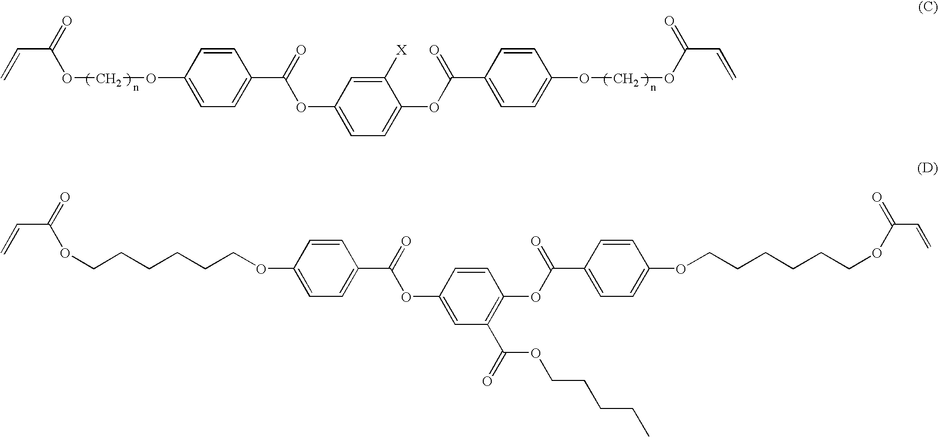
where X is hydrogen; fluorine, chlorine, bromine; or lower alkyl such as methyl, ethyl, propyl or butyl, and n is an integer from 3 to 12.

Preference is given to using polymerizable liquid-crystalline monomers whose alignment on the alignment layers is fixed (frozen in) by the polymerization. To prepare the liquid crystal layers, the same techniques can be applied as for the coating with an orientation layer. The thicknesses of the liquid crystal layer are, for example, in the range from 10 nm to 10 μm, preferably from 100 nm to 5 μm, especially preferably from 500 nm to 3 μm.

The inventively produced composite material is notable for outstanding adhesion of the liquid crystal layer to the alignment layer, and also a high photostability of the orientation layer. As a consequence of a high photosensitivity of the copolymers, excellent and uniform contrast performance is achieved, even at short irradiation times.

The examples which follow further illustrate the invention. PEG stands for polyethylene glycol. The monomer A used, 2-methoxy-4-(3-methoxy-3-oxo-1-propenyl)phenyl 4-[[8-[(2-methyl-1-oxo-2-propenyl)oxy]octyl]oxy]benzoate, has the following structural formula: 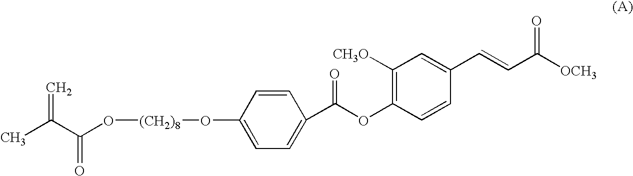
A) Preparation of Polymers

### EXAMPLE A1

### Copolymer of Polyethylene Glycol Methacrylate and Monomer A (w=0.25 g/g)

7.87 g (15 mmol) of monomer A, 2.36 g (6.4 mmol) of polyethylene glycol methacrylate (M 360 g/mol, Aldrich 40,952-7) and 35.5 mg (0.21 mmol) of 2,2′-azobisisobutyronitrile are dissolved with stirring in 76 g of tetrahydrofuran (THF) in a Schlenk tube. The reaction vessel is sealed in an air-tight manner and, to degas the mixture, the stirred, clear, colourless solution is evacuated down to 200 mbar and then aerated again with nitrogen. This procedure is repeated a total of 5 times. Subsequently, the reaction mixture is heated to 55° C. with stirring. After 15 hours, the reaction vessel is opened. The now viscous solution is diluted with 50 g of tetrahydrofuran (THF) and filtered through a 0.2 μm PTFE membrane. The filtrate is added dropwise with vigorous stirring at −10 to 0° C. to 860 g of methanol. The precipitated white polymer is voluminous and, when the stirrer is switched off, rapidly sediments on the bottom of the beaker, where it forms a tacky layer. After being left to stand at room temperature for 30 min, the crude copolymer is obtained by simply decanting off the methanol. The resulting white, rubber-like solid is immediately dissolved again in 50 g of THF and reprecipitated at −10° C. to 0° C. in 860 g of methanol. The purified copolymer which is now free of monomer is obtained again by decanting. After drying at room temperature/10 mbar, 6.76 g of colourless, amorphous, somewhat tacky powder are obtained which have the following properties:

¹H NMR: 33 mol % fraction of PEG methacrylate; T_{g}=31° C.; gel permeation chromatography (GPC, THF, 35° C., polystyrene standard): Mn=57 500 g/mol, Mw=123 000 g/mol; polydispersity (D)=2.13.

### EXAMPLE A2

### Copolymer of Polyethylene Glycol Methacrylate and Monomer A (w=0.20 g/g)

32.4 g (61.8 mmol) of monomer A, 14.7 g (40.8 mmol) of polyethylene glycol methacrylate (MW 360 g/mol; Aldrich 40,952-7) and 166 mg (1 mmol) of 2,2′-azobisisobutyronitrile are dissolved with stirring in 387 g of 1-methoxy-2-propyl acetate (MPA) in a 750 ml sulfonation flask. The reaction vessel is sealed in an air-tight manner, and, to degas the mixture, the stirred, clear, colourless solution is evacuated down to 130 mbar and aerated again with nitrogen. This procedure is repeated a total of 5 times. Subsequently, the reaction mixture is heated with stirring to 65° C. After 8 hours, 166 mg (1 mmol) of 2,2′-azobisisobutyronitrile are added once more and reaction is continued for a further 20 hours. After a total of 28 hours, the reaction vessel is opened and the now viscous solution is added dropwise with vigorous stirring at −15 to 0° C. to 1.2 l of methanol. The precipitated white polymer powder is filtered off with suction immediately and washed with several portions of cold methanol. The crude polymer soon starts to cake together and forms a tacky mass on the filter. The resulting white, rubber-like solid is immediately dissolved again in 400 ml of MPA and reprecipitated at −15° C. in 1.2 l of methanol/water (1:1). The precipitated, now monomer-free, white polymer is pulverulent, and is filtered off with suction immediately and washed with several portions of cold water. After drying at room temperature/20 mbar, 35.6 g of white powder are obtained which have the following properties:

¹H NMR: 27 mol % fraction of PEG methacrylate; T_{g}=25° C.; GPC: Mn=35400 g/mol, Mw=217 000 g/mol; D=6.11.

### EXAMPLE A3

### Copolymer of Polyethylene Glycol Methacrylate and Monomer A (w=0.21 g/g)

7.87 g (15 mmol) of monomer A, 3.45 g (6.43 mmol) of polyethylene glycol methacrylate (MW 526 g/mol, Aldrich 40,952-9) and 35.5 mg (0.21 mmol) of 2,2′-azobisisobutyronitrile are dissolved with stirring in 76 g of (THF) in a Schlenk tube. The reaction vessel is sealed in an air-fight manner and, to degas the mixture, the stirred, clear, colourless solution is evacuated down to 200 mbar and then aerated again with nitrogen. This procedure is repeated a total of 5 times. Subsequently, the reaction mixture is heated to 55° C. with stirring. After 15 hours, the reaction vessel is opened, and the now viscous solution is diluted with 50 g of THF and filtered through a 0.2 μm PTFE membrane. The filtrate is added dropwise with vigorous stirring at −10 to 0° C. to 860 g of methanol. The precipitated white polymer is voluminous and, when the stirrer is switched off, sediments rapidly on the bottom of the beaker, where it forms a tacky layer. After being left to stand at room temperature for 30 min, the crude copolymer is obtained by simply decanting off the methanol. The resulting white, rubber-like solid is immediately dissolved again in 50 g of THF and reprecipitated at −10° C. to 0° C. in 860 g of methanol. The purified copolymer which is now free of monomer is obtained again by decanting. After drying at room temperature/10 mbar, 6.53 g of colourless, amorphous, somewhat tacky material are obtained which have the following properties:

¹H NMR: 21 mol % fraction of PEG methacrylate; T_{g}=24° C.; GPC: Mn=46 600 g/mol, Mw=186 000 g/mol; D=2.82.

### EXAMPLE A4

### Copolymer of Polyethylene Glycol Methacrylate and Monomer A (w=0.24 g/g)

7.87 g (15 mmol) of monomer A, 5.37 g (10 mmol) of polyethylene glycol methacrylate (MW 526 g/mol, Aldrich 40,952-9) and 41.5 mg (0.25 mmol) of 2,2′-azobisisobutyronitrile are dissolved with stirring in 89 g of tetrahydrofuran (THF) in a Schlenk tube. The reaction vessel is sealed in an air-fight manner and, to degas the mixture, the stirred, clear, colourless solution is evacuated down to 200 mbar and then aerated again with nitrogen. This procedure is repeated a total of 5 times. Subsequently, the reaction mixture is heated to 55° C. with stirring. After 15 hours, the reaction vessel is opened, and the now viscous solution is diluted with 50 g of THF and filtered through a 0.2 μm PTFE membrane. The filtrate is added dropwise with vigorous stirring at −10 to 0° C. to 1000 g of methanol, which is initially charged in a beaker. The precipitated white polymer is voluminous and, when the stirrer is switched off, rapidly sediments on the bottom of the beaker, where it forms a tacky layer. After being left to stand at room temperature for 30 min, the crude copolymer is obtained by simply decanting. The resulting white, rubber-like solid is immediately dissolved again in 50 g of THF and reprecipitated at −10° C. to 0° C. in 1000 g of methanol. The purified copolymer which is now free of monomer is obtained again by decanting. After drying at room temperature/10 mbar, 4.41 g of colourless, amorphous, somewhat tacky material are obtained which have the following properties:

¹H NMR: 24 mol % fraction of PEG methacrylate; Tg=13° C.; GPC: Mn=59 200 g/mol, Mw=155 000 g/mol; D=2.61.

### EXAMPLE A5

### Copolymer of Polyethylene Glycol Methacrylate and Monomer A (w=0.35 g/g)

6.47 g (11.5 mmol) of monomer A, 3.84 g (9.4 mmol) of polyethylene glycol methacrylate (MW 400 g/mol, Shin Nakamura NK Ester M-90 G) and 34.7 mg (0.2 mmol) of 2,2′-azobisisobutyronitrile (Fluka 11630) are dissolved with stirring in 56 g of tetrahydrofuran (THF) in a Schlenk tube. The reaction vessel is sealed in an air-tight manner and, to degas the mixture, the stirred, clear, colourless solution is evacuated down to 200 mbar and then aerated again with nitrogen. This procedure is repeated a total of 5 times. Subsequently, the reaction mixture is heated to 55° C. with stirring. After 15 hours, the reaction vessel is opened, and the now viscous solution is diluted with 20 g of THF and filtered through a 0.2 μm PTFE membrane. The filtrate is added dropwise with vigorous stirring at −10 to 0° C. to 840 g of methanol, which is initially charged in a beaker. The precipitated white polymer is tacky and, when the stirrer is switched off, rapidly sediments on the bottom of the beaker. After being left to stand at room temperature for 30 min, the crude copolymer is obtained by simply decanting off the methanol. The resulting white, rubber-like solid is immediately dissolved again in 50 g of THF and reprecipitated at −10° C. to 0° C. in 840 g of methanol. The purified copolymer which is now free of monomer is obtained again by decanting. After drying at 40° C./10 mbar, 5.75 g of colourless, amorphous, tacky material are obtained which have the following properties:

NMR: 42 mol % fraction of PEG methacrylate; Tg=31 7° C.; GPC: Mn=62 900 g/mol, Mw=117 000 g/mol; D=1.86.

### EXAMPLE A6

### Copolymer of Polyethylene Glycol Methacrylate and Monomer A (w=0.21 g/g)

302.9 g (56 mmol) of monomer A, 128.9 g (240 mmol) of polyethylene glycol methacrylate (MW 526 g/mol, Aldrich 40,952-9) and 1.33 g (4.3 mol) of 2,2′-azobisisobutyronitrile are dissolved with stirring in 2331 g of THF in a Schlenk tube. The reaction vessel is sealed in an air-tight manner and, to degas the mixture, the stirred, clear, colourless solution is evacuated down to 200 mbar and then aerated again with nitrogen. This procedure is repeated a total of 5 times. Subsequently, the reaction mixture is heated to 55° C. with stirring. After 15 hours, the reaction vessel is opened and the now viscous solution is filtered through a 0.2 μm PTFE membrane. The filtrate is added dropwise with vigorous stirring at −10 to 0° C. to 860 g of methanol. The precipitated white polymer is voluminous and, when the stirrer is switched off, rapidly sediments on the bottom of the beaker, where it forms a tacky layer. After being left to stand at room temperature for 30 min, the crude copolymer is obtained by simply decanting off the methanol. The resulting white, rubber-like solid is used immediately to prepare a 2% by weight solution in cyclopentanone.

A portion of the material is dried and analysed. A colourless, amorphous, somewhat tacky material is obtained which has the following properties:

¹H NMR: 21 mol % fraction of PEG methacrylate; T_{g}=21° C.; GPC: Mn=66 400 g/mol, Mw=242 000 g/mol; D=3.65.

### EXAMPLE A7

### Copolymer of Polyethylene Glycol Methacrylate and Monomer A (w=0.07 g/g)

8.43 g (15 mmol) of monomer A, 1.00 g (1.86 mmol) of polyethylene glycol methacrylate (MW 526 g/mol, Aldrich 40,952-9) and 28.0 mg (0.17 mmol) of 2,2′-azobisisobutyronitrile are dissolved with stirring in 60 g of THF in a Schlenk tube. The reaction vessel is sealed in an air-tight manner and, to degas the mixture, the stirred, clear, colourless solution is evacuated down to 200 mbar and then aerated again with nitrogen. This procedure is repeated 5 times. Subsequently, the reaction mixture is heated to 55° C. with stirring. After 15 hours, the reaction vessel is opened, and the now viscous solution is diluted with 50 g of THF and filtered through a 0.2 μm PTFE membrane. The filtrate is added dropwise with vigorous stirring at −10 to 0° C. to 675 g of methanol. The precipitated white polymer is voluminous and, when the stirrer is switched off, rapidly sediments on the bottom of the beaker, where it forms a tacky layer. After being left to stand at room temperature for 30 min, the crude copolymer is obtained by simply decanting off the methanol. The resulting white, rubberlike solid is immediately dissolved again in 50 g of THF and reprecipitated at −10° C. to 0° C. in 675 g of methanol. The purified copolymer which is now free of monomer is obtained by filtering. After drying at room temperature/10 mbar, 6.20 g of colourless, pulverulent material are obtained which have the following properties:

¹H NMR: 7 mol-% fraction of PEG methacrylate; T_{g}=52° C.; GP: Mn=65 100 g/mol, Mw=149 000 g/mol; D=2.30.

### EXAMPLE A8

### Methacrylated Copolymer (from Example A2)

In a 10 ml round-bottomed flask, 800 mg of copolymer from Example 2 and 50.7 mg (0.453 mmol) of triethylamine are weighed in and dissolved in 4 g of tetrahydrofuran (THF). The flask is sealed with a rubber septum and the clear, colourless solution is evacuated by means of a cannula and aerated again with nitrogen. The clear, colourless solution is protected from light by wrapping aluminum foil around it and cooled to 0° C. using an ice bath. 51 mg (0.499 mmol) of methacryloyl chloride are then added by means of a gas-tight 250 μl syringe to this inertized and light-protected mixture and the syringe is then flushed with 0.33 g of THF. The reaction mixture becomes slightly cloudy and, after stirring for 15 minutes, the ice bath is removed and the reaction is heated to room temperature. After 2 hours of stirring, the reaction vessel is opened, and the colourless fine suspension is diluted with 3 g of THF and filtered through a 0.2 μm PTFE membrane. The filtrate is added dropwise with vigorous stirring at −10 to 0° C. to 79.1 g of methanol. Whilst the stirrer has been switched off, the precipitated white polymer sediments rapidly on the bottom of the beaker, where it forms a tacky layer. After standing at room temperature for 60 minutes, the crude copolymer is obtained by simply decanting the methanol. The resulting white, rubber-like solid is dried at room temperature/10 mbar. This results in 0.56 g of colourless, pulverulent material having the following properties:

¹H NMR: 18 mol % fraction of hydroxy-functionalized PEG, 9 mol % fraction of methacrylic-functionalized PEG and 73 mol % of monomer A; T_{g}=26° C.; GPC: Mn=18 500 g/mol, Mw=55 900 g/mol; D=3.03.

### EXAMPLE A9

### Copolymer of Polypropylene Glycol Methacrylate (PPG) and Monomer A (w=0.31 g/g)

8.43 g (15 mmol) of monomer A, 4.30 g (10 mmol) of polypropylene glycol methacrylate (MW 430 g/mol, Aldrich 46,979-3) and 41.5 mg (0.25 mmol) of 2,2′-azobisisobutyronitrile are dissolved with stirring in 78 g of THF in a Schlenk tube. The reaction vessel is sealed in an air-tight manner and, to degas the mixture, the stirred, clear, colourless solution is evacuated down to 200 mbar and then aerated again with nitrogen. This procedure is repeated a total of 5 times. Subsequently, the reaction mixture is heated to 55° C. with stirring. After 15 hours, the reaction vessel is opened, and the viscous solution is diluted with 50 g of THF and filtered through a 0.2 μm PTFE membrane. The filtrate is added dropwise with vigorous stirring at −10 to 0° C. to 1000 g of methanol, which is initially charged in a beaker. The precipitated white polymer is voluminous and, when the stirrer is switched off, rapidly sediments on the bottom of the beaker, where it forms a tacky layer. After being left to stand at room temperature for 30 min, the crude copolymer is obtained by simply decanting. The resulting white, rubberlike solid is immediately dissolved again in 50 g of THF and reprecipitated at −10° C. to 0° C. in 1000 g of methanol. The purified copolymer which is now free of monomer is obtained again by decanting. After drying at room temperature/10 mbar, 8.23 g of colourless, amorphous, somewhat tacky material are obtained which have the following properties:

¹H NMR: 35 mol % fraction of PPG methacrylate; Tg=21° C.; GPC: Mn=55 100 g/mol, Mw=113 000 g/mol; D=2.06.

B) Production of Backings with Copolymer Layer

### EXAMPLE B1

A solution of 2% by weight of the copolymer of Example A1 in 7 ml of cyclopentanone is prepared. The solution is applied by spinning in a spin-coating apparatus to an ITO-coated glass plate for 60 seconds and 3 000 rpm (acceleration=500 rps), in such a way that a homogeneous layer of 50 nm is formed. Afterwards, the layer is dried at 180° C. for 10 minutes and irradiated with 20 mJ/cm² of linear-polarized light at a wavelength of 280 to 320 nm.

### EXAMPLES B2-B9

The procedure of Example B1 is repeated, but the copolymers of Examples A2 to A9 are used.

C) Production of Backings with Copolymer Layer and Liquid-Crystalline Layer

### EXAMPLE C1

A 15% by weight solution of a commercial photocrosslinkable liquid crystal formulation in cyclopentanone is used (OPALVATM 2130, Vantico AG) and spin-coated onto the copolymer layer of the coated glass plate of Example B1 using a spin-coating apparatus (120 seconds at 1 000 rpm, acceleration 500 rps), in such a way that a homogeneous layer having a thickness of 700-800 nm is formed. The applied layer is aligned by heating to 50° C. (1 minute) and 40° C. (1 minute). Afterwards, the aligned layer is crosslinked under nitrogen by irradiation with 800 nmJ/cm² of UV light in the range of 280-400 nm.

### EXAMPLES C2-C9

The procedure of Example C1 is repeated and the coated glass plates of Examples B2 to B9 are used.

D) Application Examples

### EXAMPLE D1

### Testing of the Adhesion

The layers of the coated plates of Examples C1 to C9 are cross-cut down to the glass plate using a multiblade cutter and thus divided into 100 fields. An adhesive tape (3M Magic Scotch Tape) is then stuck to the cut layer and this tape is provided with a further adhesive tape (Sekisui Tape, this test is a standard test of Japanese industry). Afterwards, the adhesive tape is removed rapidly and the damaged fields are determined. The results are given in Table 1. For comparison, a homopolymer of monomer A (glass transition temperature 62° C., comparison 1) and a copolymer of monomer A with hydroxyethyl methacrylate (20% by weight, glass transition temperature 62° C., comparison 2) are also tested.

TABLE 1

| Plates of example | Adhesion (damaged fields/100) |
|---|---|
| C1 | 10/100 |
| C2 | 10/100 |
| C3 | 0/100 |
| C4 | 15/100 |
| C5 | 20/100 |
| C6 | 0/100 |
| C7 | 40/100 |
| C8 | 3/100 |
| C9 | 20/100 |
| Comparison 1 | 90/100 |
| Comparison 2 | 95/100 |

### EXAMPLE D2

### Determination of Optical Properties

The coated plates with layers of the copolymers A1 to A9 and of comparison 1 and comparison 2 are irradiated in accordance with Examples B1 to B9 successively in strips with energy doses of 5/10/20/30/40 and 50 mJ/cm² with linear-polarized light in the range of 280-320 nm. A layer of photocrosslinked liquid crystals is then applied in accordance with Example C1.

Contrast and tilt angle are determined with a microscope which is additionally equipped with a Berek compensator which enables measurements of birefringences. The number of tilt domains B_{tilt domain} in the irradiated strips is determined visually with the microscope. Tilt domains refer to regions of the coating having different bit angles. In cross-polarized light, the boundaries between these zones can be discerned by sharply delimited contrast differences. The presence of tilt domains shows that the orientation is not yet complete and is thus a measure of the photospeed of the orientation layer. The results are given in Table 2.

The contrast is the quotient between the brightest and the darkest setting and is given by the following equation: contrast=I (bright)/I (dark) [I (bright) is the intensity of the brightest setting, I (dark) is the intensity of the darkest setting]. The intensities are measured with the aid of a photodetector.

TABLE 2

| Plates | | | |
|---|---|---|---|
| of example | Contrast | B_{tilt domain}^{1),2)} | Tilt angle²⁾ |
| C1 | Good, >100 | +/−/−/−/−/− | 0° |
| C2 | Good, >100 | +/−/−/−/−/− | 0° |
| C3 | Good, >100 | −/−/−/−/−/− | 0° |
| C4 | Good, >100 | ++/−/−/−/−/− | 0° |
| C5 | Good, >100 | ++/−/−/−/−/− | 0° |
| C6 | Good, >100 | −/−/−/−/−/− | 0° |
| C7 | Good | −/−/−/−/−/− | approx. 30° (very good |
| | | | stability); stable between |
| | | | 3 and 20 mJ/cm² |
| C8 | Good, >100 | −/−/−/−/−/− | 0° |
| C9 | Average | ++/+/−/−/−/− | 0°; stable between |
| | | | 10 and 20 mJ/cm² |
| Comparison 1 | Average | ++/+/−/−/−/− | approx. 27°; stable between |
| | | | 15 and 30 mJ/cm² |
| Comparison 2 | Average | ++/+/−/−/−/− | Not stable |

¹⁾+++ is very many; ++ is many; + is few; − is none
²⁾Irradiation energies of 5/10/20/30/40/50 mJ/cm²

1. Copolymer composed of
(a) at least one monomer from the group of acrylates, methacrylates, acrylamides and methacrylamides, to each of which is bonded covalently, directly or via a bridging group, a photochemically isomerizable or dimerizable molecule,
(b) at least one comonomer containing hydroxyl groups, and
(c) optionally, other ethylenically unsaturated comonomers,
characterized in that the comonomer (b) is a polyoxyalkyl ester or a polyoxyalkylamide of an ethylenically unsaturated mono- or dicarboxylic acid, or a polyoxyalkyl ether of an ethylenically unsaturated alcohol, and the hydroxyl group of the polyoxyalkylene radical may be etherified or esterified.

2. Copolymer according to claim 1, characterized in that the photochemically isomerizable group of component a) is an ethylenically unsaturated group which is bonded to a carbocyclic or heterocyclic, aromatic ring.

3. Copolymer according to claim 2, characterized in that the photopolymerizable group corresponds to the formulae A or B 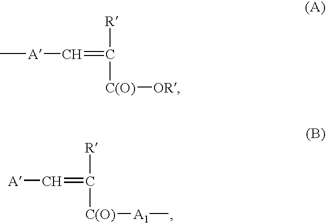
where
R′ is hydrogen or C₁-C₄-alkyl,
A′ is an optionally substituted mono- or divalent aromatic radical or an optionally substituted mono- or divalent heteroaromatic radical, and
A₁ is a bridging group.

4. Copolymer according to claim 1, characterized in that the monomers (a) correspond to the formula I or to the formula Ia 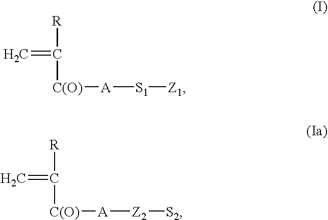
where
R is H or C₁-C₆-alkyl,
A is a bridging group,
S₁ is an optionally substituted divalent, and S₂ an optionally substituted monovalent, aromatic or heteroaromatic radical, and
Z₁ is a monovalent, and Z₂ a divalent, radical of a molecule which isomerizes or dimerizes photochemically.

5. Copolymer according to claim 1, characterized in that the monomers (a) correspond to the formula Ib or to the formula Ic, 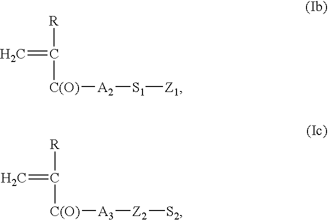
where
R is hydrogen or methyl,
A₂ is a bivalent radical of the formula —O—CₙH₂ₙ—X₁—,
A₃ is a bivalent radical of the formula —O—CₙH₂ₙ—O—,
n is a number from 2 to 18 and preferably from 4 to 16,
X₁ is a direct bond or an —O—, —S—, —C(O)O—, —O(O)C—, —OC(O)O—, —NH—, —NC₁-C₄-alkyl-, —NHC(O)—, —C(O)NH—, —NHC(O)NH—, —NC₁-C₄-alkyl-C(O)—, —C(O)NC₁-C₄-alkyl-, —NC₁-C₄-alkyl-C(O)—NC₁-C₄-alkyl-, —O(CO)NH—, —OC(O)—NC₁-C₄-alkyl-, —NHC(O)O— or —NC₁-C₄-alkyl-C(O)O— group,
S₁, where present, is phenylene, biphenylene or —C₆H₄—X₂—C₆H₄—,
S₂, where present, is substituted phenyl, biphenyl or —C₆H₄—X₂—C₆H₅,
X₂ is —O—, —S—, —C(O)O—, —O(O)C—, —OC(O)O—, —NH—, —NC₁-C₄-alkyl-, —NH C(O)—, —C(O)N H—, —NHC(O)NH—, —NC, —C₄-alkyl-C(O)—, —C(O NC, —C₄-alkyl-, —NC₁-C₄-alkyl-C(O)—NC₁-C₄-alkyl-, —O(CO)NH—, —OC(O)—NC₁-C₄-alkyl-, —NHC(O)O— or —NC₁-C₄-alkyl-C(O)O—,
Z₁ is a radical of the formula —CH═CH—C(O)—OR₁,
Z₂ is a radical of the formula CH═CH—C(O)—, and
R₁ is C₁-C₁₈-alkyl, more preferably C₁-C₁₂-alkyl, and especially preferably C₁-C₄-alkyl.

6. Copolymer according to claim 1, characterized in that the monomers (a) correspond to the formula Id or to the formula Ie 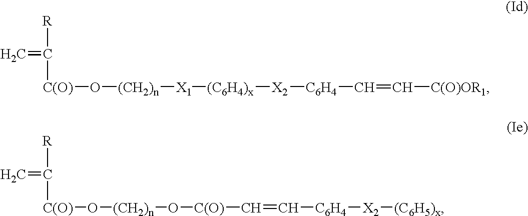
where
R is methyl,
n is a number from 2 to 20, preferably from 4 to 14,
R₁ is C₁-C₄-alkyl and preferably methyl,
x is 0 or 1,
X₂ is a direct bond, —O—, —S—, —CO—, OC(O)— or —C(O)O—, and
the C₆H₄ and C₆H₅ groups are each independently unsubstituted or substituted by 1 to 3 C₁-C₄alkyl and/or C₁-C₄-alkoxy, preferably methoxy.

7. Copolymer according to claim 1, characterized in that the comonomers (b) correspond to the formula II, 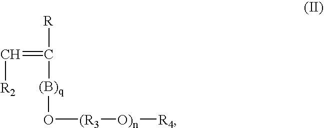
where
R is H or C₁-C₄-alkyl,
R₂ is H or —COOR₅,
R₃ is C₂-C₆-alkylene,
R₄ is H, —R₆— or R₆—C(O)—,
B is methylene or —C(O)—,
q is 0 or 1,
n is a number from 2 to 200,
R₅ is H, C₁-C₂₀-alkyl, phenyl, phenyl-C₁-C₆-alkyl or C₁-C₁₈-alkylphenyl, and
R₆ is C₁-C₂₀-alkyl, phenyl, phenyl-C₁-C₆-alkyl, or C₁-C₁₈-alkylphenyl, or, in the R₆C(O)— group, is additionally C₂-C₁₈-alkenyl or phenyl-C₂-C₆-alkenyl.

8. Copolymer according to claim 7, characterized in that R is H or methyl.

9. Copolymer according to claim 7, characterized in that R₂ is H.

10. Copolymer according to claim 7, characterized in that R₃ is ethylene or 1,2-propylene or mixtures of these radicals.

11. Copolymer according to claim 7, characterized in that R₄ is preferably H, C₁-C₁₂-alkyl or C₁-C₁₂-alkyl-C(O)—.

12. Copolymer according to claim 7, characterized in that B is —C(O)—.

13. Copolymer according to claim 7, characterized in that the index n is a number from 2 to 100.

14. Copolymer according to claim 7, characterized in that the comonomers of the formula II are acrylic or methacrylic monoesters of polyethylene glycols or polypropylene 1,2-glycols having on average 2 to 20 oxyethylene or oxypropylene units.

15. Copolymer according to claim 1, characterized in that the monomers (c) are unsubstituted or substituted olefins or diolefins.

16. Copolymer according to claim 15, characterized in that the comonomer (c) is ethene, propene, butene, pentene, styrene, vinyl chloride, vinylidene chloride, (meth)acrylonitrile, (meth)acrylamide, N-alkylated or N-hydroxyalkylated (meth)acrylamide, alkyl (meth)acrylates and hydroxyalkyl (meth)acrylates having 1 to 20 carbon atoms in the ester group, vinyl and allyl esters, and also vinyl and allyl ethers, having 1 to 20 carbon atoms in the ester or ether groups.

17. Copolymer according to claim 1, characterized in that it additionally contains radicals of monomers having at least two ethylenically unsaturated groups.

18. Copolymer according to claim 1, characterized in that some or all of the hydroxyl groups of the polyoxyalkyl radicals of the comonomers (b) have been esterified with radicals of ethylenically unsaturated monocarboxylic acids.

19. Copolymer according to claim 18, characterized in that the monocarboxylic acid is acrylic acid or methacrylic acid.

20. Copolymer according to claim 1, characterized in that the glass transition temperature is at most 70° C.

21. Copolymer according to claim 20, characterized in that the copolymers have a glass transition temperature of at most 50° C.

22. Copolymer according to claim 1, characterized in that 10 to 95% by weight of comonomer (a), and 90 to 5% by weight of comonomer (b) are present, based on the copolymer.

23. Copolymer according to claim 1, characterized in that the comonomer (c) replaces 50 to 1% by weight of the comonomer (b).

24. Coating composition comprising, in an organic solvent, a copolymer composed of
(a) at least one monomer from the group of acrylates, methacrylates, acrylamides and methacrylamides, to each of which is bonded covalently, directly or via a bridging group, a photochemically isomerizable or dimerizable molecule,
(b) at least one comonomer containing hydroxyl groups, and
(c) optionally, other ethylenically unsaturated comonomers,
characterized in that the comonomer (b) is a polyoxyalkyl ester or a polyoxyalkylamide of an ethylenically unsaturated mono- or dicarboxylic acid, or a polyoxyalkyl ether of an ethylenically unsaturated alcohol, and the hydroxyl group of the polyoxyalkylene radical may be etherified or esterified.

25. Polymerizable composition comprising
(a) at least one monomer from the group of acrylates, methacrylates, acrylamides and methacrylamides, to each of which is bonded covalently, directly or via a bridging group, a photochemically isomerizable or dimerizable molecule,
(b) at least one copolymerizable comonomer containing hydroxyl groups,
(c) optionally, other ethylenically unsaturated comonomers,
(d) a polymerization initiator, and
(e) optionally, an inert solvent,
characterized in that the comonomer (b) is a polyoxyalkyl ester or a polyoxyalkylamide of an ethylenically unsaturated mono- or dicarboxylic acid, or a polyoxyalkyl ether of an ethylenically unsaturated alcohol.

26. Composite material composed of a backing and a thin layer of a polymerizable composition or a thin layer of a copolymer of this composition, comprising
(a) at least one monomer from the group of acrylates, methacrylates, acrylamides and methacrylamides, to each of which is bonded covalently, directly or via a bridging group, a photochemically isomerizable or dimerizable molecule,
(b) at least one copolymerizable comonomer containing hydroxyl groups,
(c) optionally, other ethylenically unsaturated comonomers, and
(d) a polymerization initiator,
characterized in that the comonomer (b) is a polyoxyalkyl ester or a polyoxyalkylamide of an ethylenically unsaturated mono- or dicarboxylic acid, or a polyoxyalkyl ether of an ethylenically unsaturated alcohol.
